(19) United States
(12) Patent Application Publication
(10) Pub. No.: US 2025/0279093 A1
(43) Pub. Date: Sep. 4, 2025

(54) Speculative ASR Decoding to Reduce Overall Latency of Speech Applications

(71) Applicant: Google LLC, Mountain View, CA (US)

(72) Inventors: Andrew Rosenberg, Brooklyn, NY (US); Bhuvana Ramabhadran, Mt. Kisco, NY (US); Bolaji Yusuf, Mountain View, CA (US); Murali Karthick Baskar, Mountain View, CA (US)

(73) Assignee: Google LLC, Mountain View, CA (US)

(21) Appl. No.: 19/051,473

(22) Filed: Feb. 12, 2025

Related U.S. Application Data
(60) Provisional application No. 63/559,668, filed on Feb. 29, 2024.

(51) Int. Cl. G10L 15/16; G10L 15/06

(52) U.S. Cl. CPC G10L 15/16; G10L 15/063

(57) ABSTRACT

A method includes receiving a training utterance including a sequence of audio frames and a corresponding ground-truth transcription and truncating a suffix portion from the sequence of audio frames to provide a prefix sequence of the audio frames. The method also includes processing, using a speech recognition model, the prefix sequence of audio frames to provide a partial speech recognition hypothesis and processing, using a prefix embedding multi-head attention layer, a sequence of prefix encodings to generate a prefix prompt embedding. The method also includes processing, using a LM, the partial speech recognition hypothesis conditioned on the prefix prompt embedding to generate a speculated speech recognition (SSR) hypothesis and determining a training loss based on the SSR hypothesis and the ground-truth transcription. The method also includes fine-tuning parameters of the prefix embedding multi-head attention layer.

### CROSS REFERENCE TO RELATED APPLICATIONS

This U.S. patent application claims priority under 35 U.S.C. § 119 (e) to U.S. Provisional Application 63/559,668, filed on Feb. 29, 2024. The disclosure of this prior application is considered part of the disclosure of this application and is hereby incorporated by reference in its entirety.

### TECHNICAL FIELD

This disclosure relates to speculative ASR decoding to reduce overall latency of speech applications.

### BACKGROUND

The experience of users interacting with an automatic speech recognition (ASR) system is colored by its latency, characterizing who quickly the ASR system is able to respond to user requests, in addition to speech recognition accuracy. An ASR system which can respond quickly to user queries is generally preferred to slower ASR systems with similar accuracy. While many training objectives have been developed to encourage early-output symbol emission to reduce latency as close to zero without incurring significant degradation in speech recognition accuracy, the best case scenario is for these ASR models to finish transcribing audio just as a user finishes speaking. However, in digital assistant interactions where speech recognition of a spoken query is only the first step in user interaction, speech recognition is typically followed by some form of natural language processing (NLP) to ascertain an action specified by the transcription of the query for the digital assistant to perform. Therefore, even if latency of the ASR model for generating the transcription were to reach zero, the overall end-to-end latency experienced by the user until the digital assistant performs the action, would still be above zero. Speculative speech recognition (SSR) empowers conventional speech recognition systems with speculation capabilities to allow speech recognition to run ahead of input audio characterizing an utterance spoken by a user before the user finishes speaking the utterance.

### SUMMARY

One aspect of the disclosure provides a computer-implemented method executed on data processing hardware that causes the data processing hardware to perform operations that include receiving a training utterance including a sequence of audio frames characterizing an utterance and a corresponding ground-truth transcription of the utterance and truncating a suffix portion from the sequence of audio frames to provide a prefix sequence of the audio frames that characterizes a prefix portion of the utterance. The operations also include processing, using a speech recognition model including an encoder and a decoder, the prefix sequence of the audio frames to generate a partial speech recognition hypothesis for the prefix portion of the utterance, and processing, using a prefix embedding multi-head attention layer, a sequence of prefix encodings encoded by the encoder of the speech recognition model from the prefix sequence of audio frames to generate a prefix prompt embedding. The operations also include processing, using a language model (LM), the partial speech recognition hypothesis generated by the speech recognition model conditioned on the prefix prompt embedding to generate a speculated speech recognition hypothesis for the truncated suffix portion of the sequence of audio frames. The operations also include determining a training loss based on the speculated speech recognition hypothesis and the ground-truth transcription of the utterance and fine-tuning, using the training loss, parameters of the prefix embedding multi-head attention layer.

Implementations of the disclosure may include one or more of the following optional features. In some implementations, the operations also include obtaining a sequence of trainable query vectors, wherein processing the sequence of prefix encodings encoded by the encoder to generate the prefix prompt embedding includes processing, using the prefix embedding multi-head attention layer, the sequence of prefix encodings and the sequence of trainable query vectors to generate the prefix prompt embedding. In these implementations, the trainable query vectors may include soft prompt query vectors and fine-tuning further includes fine-tuning the trainable query vectors.

In some examples, fine-tuning further includes performing parameter-efficient fine-tuning (PEFT) to only update a subset of existing or newly added parameters of the LLM based on the training loss. Here, the LM may be pre-trained and include a plurality of multi-head attention blocks, the pre-trained LM may be modified to add two low-rank projection matrices to each multi-head attention block, and performing PEFT may include fine-tuning only the parameters of the low-rank projection matrices added to the pre-trained LM while existing parameters of the pre-trained LM remain fixed.

In some implementations, the encoder of the speech recognition model includes a pre-trained audio encoder comprising a plurality of multi-head attention layers each including a multi-head attention mechanism and parameters of the pre-trained audio encoder are held fixed. In these implementations, the multi-head attention layers may include Conformer layers. Further, the LLM may include a plurality of multi-head attention layers that may include Transformer layers. Additionally, the speech recognition model may include a recurrent neural network-transducer architecture.

Another aspect of the disclosure provides a system including data processing hardware and memory hardware in communication with the data processing hardware and storing instructions that when executed on the data processing hardware causes the data processing hardware to perform operations that include receiving a training utterance including a sequence of audio frames characterizing an utterance and a corresponding ground-truth transcription of the utterance and truncating a suffix portion from the sequence of audio frames to provide a prefix sequence of the audio frames that characterizes a prefix portion of the utterance. The operations also include processing, using a speech recognition model including an encoder and a decoder, the prefix sequence of the audio frames to generate a partial speech recognition hypothesis for the prefix portion of the utterance, and processing, using a prefix embedding multi-head attention layer, a sequence of prefix encodings encoded by the encoder of the speech recognition model from the prefix sequence of audio frames to generate a prefix prompt embedding. The operations also include processing, using a language model (LM), the partial speech recognition hypothesis generated by the speech recognition model conditioned on the prefix prompt embedding to generate a speculated speech recognition hypothesis for the truncated suffix portion of the sequence of audio frames. The operations also include determining a training loss based on the speculated speech recognition hypothesis and the ground-truth transcription of the utterance and fine-tuning, using the training loss, parameters of the prefix embedding multi-head attention layer.

Implementations of the disclosure may include one or more of the following optional features. In some implementations, the operations also include obtaining a sequence of trainable query vectors, wherein processing the sequence of prefix encodings encoded by the encoder to generate the prefix prompt embedding includes processing, using the prefix embedding multi-head attention layer, the sequence of prefix encodings and the sequence of trainable query vectors to generate the prefix prompt embedding. In these implementations, the trainable query vectors may include soft prompt query vectors and fine-tuning further includes fine-tuning the trainable query vectors.

In some examples, fine-tuning further includes performing parameter-efficient fine-tuning (PEFT) to only update a subset of existing or newly added parameters of the LLM based on the training loss. Here, the LM may be pre-trained and include a plurality of multi-head attention blocks, the pre-trained LM may be modified to add two low-rank projection matrices to each multi-head attention block, and performing PEFT may include fine-tuning only the parameters of the low-rank projection matrices added to the pre-trained LM while existing parameters of the pre-trained LM remain fixed.

In some implementations, the encoder of the speech recognition model includes a pre-trained audio encoder comprising a plurality of multi-head attention layers each including a multi-head attention mechanism and parameters of the pre-trained audio encoder are held fixed. In these implementations, the multi-head attention layers may include Conformer layers. Further, the LLM may include a plurality of multi-head attention layers that may include Transformer layers. Additionally, the speech recognition model may include a recurrent neural network-transducer architecture.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of a system executing a speculative speech recognition model.

FIG. 2 is a schematic view of an example speech recognition model having a recurrent neural network-transducer architecture.

FIG. 3 is a schematic view of an example training process for training the speculative speech recognition model of FIG. 1.

FIG. 4 is a schematic view of an example Alignment With Subsequence Edit Distance (AWSED) procedure executed by the training process of FIG. 3

FIG. 5 is a flowchart of an example arrangement of operations for a computer-implemented method of training the speculative speech recognition model.

FIG. 6 is a schematic view of an example computing device that may be used to implement the systems and methods described herein.

Like reference symbols in the various drawings indicate like elements.

### DETAILED DESCRIPTION

The experience of users interacting with an automatic speech recognition (ASR) system is colored by its latency, characterizing who quickly the ASR system is able to respond to user requests, in addition to speech recognition accuracy. An ASR system which can respond quickly to user queries is generally preferred to slower ASR systems with similar accuracy. While many training objectives have been developed to encourage early-output symbol emission to reduce latency as close to zero without incurring significant degradation in speech recognition accuracy, the best case scenario is for these ASR models to finish transcribing audio just as a user finishes speaking. However, in digital assistant interactions where speech recognition of a spoken query is only the first step in user interaction, speech recognition is typically followed by some form of natural language processing (NLP) to ascertain an action specified by the transcription of the query for the digital assistant to perform. Therefore, even if latency of the ASR model for generating the transcription were to reach zero, the overall end-to-end latency experienced by the user until the digital assistant performs the action, would still be above zero.

Prefetching techniques provide a template for reducing the end-to-end latency further by hinging on the observation that there is a delay between an ASR system's emission of a last output symbol recognized and being able to confidently determine that the user has finished speaking an utterance. Namely, ASR hypotheses output by the ASR system are sent downstream for NLP processing as soon as a token is emitted without waiting for the end-of-utterance confirmation such that downstream NLP computation can commence immediately. Thus, these prefetching techniques mitigate end pointing latency in exchange for extra computation overhead.

Large language models (LLMs) have become more popular in recent years. A number of recent studies have explored the use of LLMs for spoken language understanding and fine-tuning the LLMs on audio data to perform speech-to-text question answering tasks. These models were able to answer text questions in response to input audio in a direct manner. Speculative speech recognition (SSR) empowers conventional speech recognition systems with speculation capabilities to allow speech recognition to run ahead of input audio characterizing an utterance spoken by a user before the user finishes speaking the utterance.

Implementations herein are directed towards a SSR model and methods of training and executing the SSR model to accurately generate a full transcription of an utterance spoken by a user before the user has finished speaking the utterance. Specifically, implementations are directed toward the SSR model including an automated speech recognition (ASR) model and a large language model (LLM) modified such that the LLM receives, as input, a partial speech recognition hypothesis output by the ASR model for a prefix portion of an utterance and an audio-dependent prefix prompt embedding generated by a prefix embedding multi-head attention layer, and generates, as output, a speculated speech recognition hypothesis for a suffix portion of the utterance. Here, the prefix portion of the utterance is spoken by a user before the user speaks the suffix portion of the utterance and the audio-dependent prefix prompt embedding generated by the prefix embedding multi-head attention layer is based on a sequence of prefix encodings encoded by an audio encoder of the ASR model from a sequence of audio frames characterizing the prefix portion of the utterance. Thereafter, a downstream component may proactively process a transcription of the utterance formed by the partial speech recognition hypothesis output by the ASR model for the prefix portion of the utterance and the SSR hypothesis output by the LLM for the suffix portion of the utterance to identify an action for an application (e.g., a digital assistant) to perform before the user completes speaking the suffix portion of the utterance. Thus, the ability of the SSR model to accurately generate full transcriptions of utterances before the complete utterance is finished can permit initiation of downstream query interpretation (e.g., NLP) operations early to reduce the end-to-end latency of fulfilling tasks specified by user utterances.

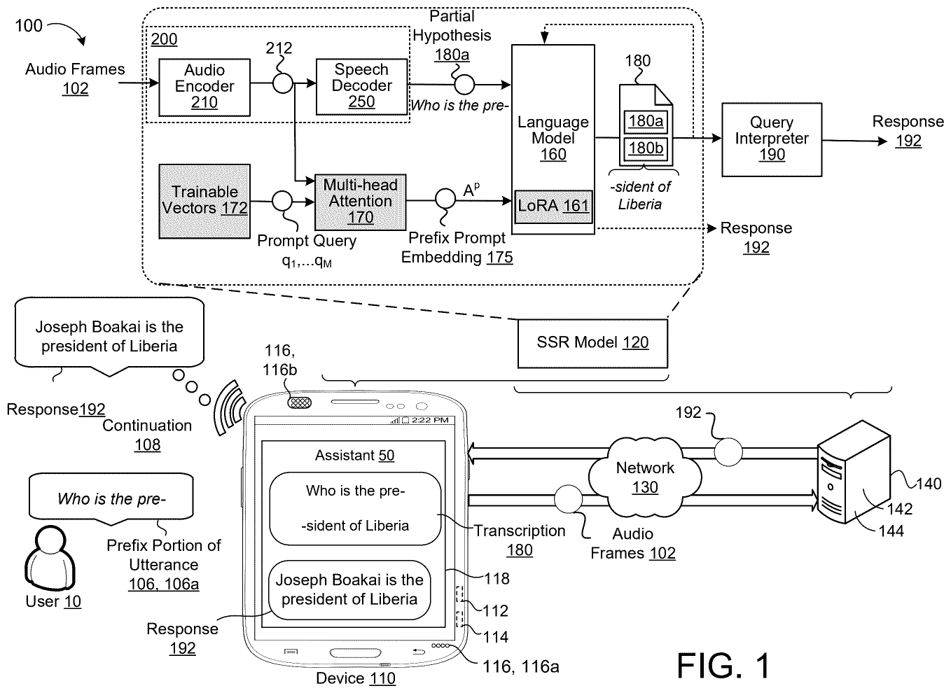

FIG. 1 illustrates an example system 100 whereby a user 10 may interact with a computing device, such as a user device 110, through voice input. The user device 110 (also referred to generally as a device 110) is configured to capture sounds (e.g., streaming audio data) from one or more users 10. Here, the streaming audio data may refer to an utterance 106 spoken by the user 10 that functions as an audible prompt/query, a command for the user device 110, or an audible communication captured by the user device 110. Speech-enabled systems of the user device 110 may field the query or command by answering the query and/or causing the command to be performed/fulfilled by one or more downstream applications. For instance, in the example shown, the user 10 interacts with a digital assistant 50 of the user device 110 that uses a speculative speech recognition (SSR) model 120. The digital assistant 50 displays a digital assistant interface 118 on a screen of the user device 110 to depict a conversation between the user 10 and the digital assistant 50.

The user device 110 may correspond to any computing device associated with the user 10 and capable of receiving audio data. Some examples of user devices 110 include, but are not limited to, mobile devices (e.g., mobile phones, tablets, laptops, etc.), computers, wearable devices (e.g., smart watches), smart appliances, internet of things (IoT) devices, vehicle infotainment systems, smart displays, smart speakers, etc. The user device 110 includes data processing hardware 112 and memory hardware 114 in communication with the data processing hardware 112 and stores instructions, that when executed by the data processing hardware 112, causes the data processing hardware 112 to perform one or more operations. The user device 110 further includes an audio system 116 with an audio capture device (e.g., microphone) 116, 116a for capturing and converting the utterances 106 spoken by the user 10 into electrical signals and a speech output device (e.g., speaker) 116, 116b for communicating an audible audio signal (e.g., as output audio data from the user device 110). That is, the audio capture device 116a may convert the utterances 106 spoken by the user 10 into a sequence of audio frames 102. While the user device 110 implements a single audio capture device 116a in the example shown, the user device 110 may implement an array of audio capture devices 116a without departing from the scope of the present disclosure, whereby one or more capture devices 116a in the array may not physically reside on the user device 110, but be in communication with the audio system 116.

The user device 110 communicates with a remote system 140 via a network 130. The remote system 140 may be a distributed system (e.g., cloud computing environment) having scalable elastic resources. The resources include computing resources (e.g., data processing hardware) 142 and/or storage resources (e.g., memory hardware) 144. Additionally or alternatively, the remote system 104 may be a centralized system. The network 130 may be wired, wireless, or a combination thereof, and may include private networks and/or public networks, such as the Internet.

The SSR model 120 may execute on the user device 110, the remote system 140, or some combination thereof. The SSR model 120 is configured to receive, as input, a sequence of audio frames 102 characterizing a prefix portion 106a of an utterance 106 spoken by a user before the user 10 speaks a suffix portion of the utterance 106, and generate, as output, both a partial speech recognition hypothesis for the prefix portion 106a of the utterance 106 and a speculated speech recognition hypothesis 180b for the suffix portion of the utterance 106 before the user completes speaking the suffix portion of the utterance 106. A transcription 180 of the utterance 106 is formed by the partial speech recognition hypothesis 180a and the speculated speech recognition hypothesis 180b. Thereafter, a downstream query interpreter 190 processes the transcription 180 of the utterance 106 to identify an action for the digital assistant 50 (or other software application) to perform. The query interpreter 190 may include a downstream natural language processing (NLP) and/or natural language understanding (NLU) module configured to identify the action proactively before the user completes speaking the utterance. Optionally, the query interpreter 190 may include a language model (LM) 160 of the SSR model 120. After identifying the action, the query interpreter 190 may fulfill performance of the action and provide a response 192 for output from the user device 110 indicating fulfillment of the action. As will become apparent, the SSR model 120 is trained to generate the speculative hypothesis 180b for the suffix portion of the utterance 106 before the user 10 speaks the suffix portion of the utterance 106 based on the partial speech recognition hypothesis 180a generated for the prefix portion 106a of the utterance 106 and an audio-dependent prefix prompt embedding 175 generated by a prefix embedding multi-head attention layer 170 based on the sequence of audio frames 102 characterizing the prefix portion 106a of the utterance 106.

In some examples, the utterances 106 spoken by the user 10 correspond to spoken prompts. As such, utterances 106 may be interchangeably referred to as “spoken prompts” herein. Spoken prompts 106 may include any query, command, or other audible communication captured by the user device 110 (e.g., any command or query spoken by the user 10).

In the example shown, the user speaks “Who is the pre-” as the prefix portion 106a of the utterance 106 and the SSR model 120 generates the SSR hypothesis 180b of “-sident of Liberia” as the suffix portion of the utterance 106 before the user speaks the suffix portion of the utterance. Here, the transcription 180 formed by the partial speech recognition hypothesis 180a and the SSR hypothesis 180b may be a question spoken by the user 10 whereby the digital assistant 50 obtains “Joseph Boakai is the present of Liberia” as a response 192 that answers the question. After the query interpreter 190 identifies the action, the present disclosure is not limited to how the digital assistant 50 or other downstream application fulfills the action to obtain the response 192. For instance, the digital assistant 50 may input the transcription 180 as a search query to a search engine to obtain the response 192 from the search engine. In other examples, the LM 160 may process the transcription 180 as a textual prompt to generate the response 192. The query interpreter 190 may identify the action as a command for an automation device to perform an operation such as “turning lights on” or “playing a music playlist”, whereby the digital assistant 50 may provide a response 192 indicating the operation has been performed by the automation device.

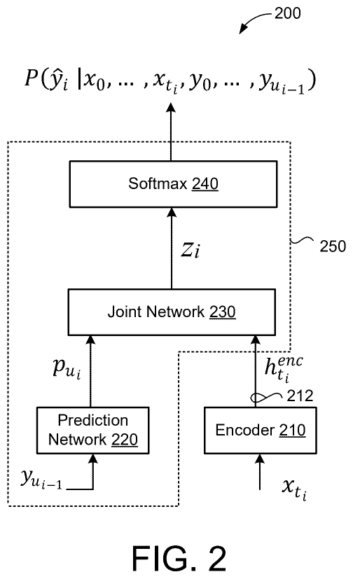

The SSR model 120 includes a speech recognition model 200, a prefix embedding multi-head attention layer 170, and the LM 160. The speech recognition model 200 includes an audio encoder 210 and a speech decoder 250. In some implementations, the speech recognition model 200 includes a recurrent neural network-transducer (RNN-T) model architecture or other frame alignment-based transducer model which adheres to latency constraints associated with interactive applications. Referring to FIG. 2, an example frame alignment-based transducer model 200 includes a Recurrent Neural Network-Transducer (RNN-T) model architecture is shown. The use of the RNN-T model architecture is exemplary, and the frame alignment-based transducer model 200 may include other architectures such as transformer-transducer and conformer-transducer model architectures among others. The RNN-T model 200 provides a small computational footprint and utilizes less memory requirements than conventional ASR architectures, making the RNN-T model architecture suitable for performing speech recognition entirely on the user device 110 (e.g., no communication with a remote server is required). The RNN-T model 200 includes the audio encoder 210, a prediction network 220, and a joint network 230. The audio encoder 210, which is roughly analogous to an acoustic model (AM) in a traditional ASR system, includes a stack of self-attention layers (e.g., Conformer or Transformer layers) or a recurrent network of stacked Long Short-Term Memory (LSTM) layers. For instance, the audio encoder 210 reads a sequence of d-dimensional feature vectors (e.g., audio frames 102 (FIG. 1)) x=(x₁, x₂, . . . , x_{T}), where xₜ∈Rd, and produces at each output step a higher-order feature representation. This higher-order feature representation is denoted as h₁^{enc}, . . . , h_{T}^{enc} and may be interchangeably referred to as an audio encoding 212.

Similarly, the prediction network 220 is also an LSTM network, which, like a language model (LM), processes the sequence of non-blank symbols output by a final Softmax layer 240 so far, y₀, . . . , yᵤᵢ₋₁, into a dense representation pᵤ_{ᵢ}. Finally, with the RNN-T model architecture, the representations produced by the encoder and prediction/decoder networks 210, 220 are combined by the joint network 230. The prediction network 220 may be replaced by an embedding look-up table to improve latency by outputting looked-up sparse embeddings in lieu of processing dense representations.

The joint network then predicts P(yᵢ|xₜ_{ᵢ}, y₀, . . . , yᵤ_{_{i−1}}), which is a distribution over the next output symbol. Stated differently, the joint network 230 generates, at each output step (e.g., time step), a probability distribution over possible speech recognition hypotheses. Here, the “possible speech recognition hypotheses” correspond to a set of output labels each representing a symbol/character in a specified natural language. For example, when the natural language is English, the set of output labels may include twenty-seven (27) symbols, e.g., one label for each of the 26-letters in the English alphabet and one label designating a space. Accordingly, the joint network 230 may output a set of values indicative of the likelihood of occurrence of each of a predetermined set of output labels. This set of values can be a vector and can indicate a probability distribution over the set of output labels. In some cases, the output labels are graphemes (e.g., individual characters, and potentially punctuation and other symbols), but the set of output labels is not so limited. For example, the set of output labels can include wordpieces, phonemes, and/or entire words, in addition to or instead of graphemes. The output distribution of the joint network 230 can include a posterior probability value for each of the different output labels. Thus, if there are 100 different output labels representing different graphemes or other symbols, the output yᵢ of the joint network 230 can include 100 different probability values, one for each output label. The probability distribution can then be used to select and assign scores to candidate orthographic elements (e.g., graphemes, wordpieces, and/or words) in a beam search process (e.g., by the Softmax layer 240) for determining the transcription 120.

The Softmax layer 240 may employ any technique to select the output label/symbol with the highest probability in the distribution as the next output symbol predicted by the RNN-T model 200 at the corresponding output step. In this manner, the RNN-T model 200 does not make a conditional independence assumption, rather the prediction of each symbol is conditioned not only on the acoustics but also on the sequence of labels output so far. The RNN-T model 200 does assume an output symbol is independent of future acoustic frames 102, which allows the RNN-T model to be employed in a streaming fashion.

In some examples, the audio encoder 210 of the RNN-T model 200 includes a stack of self-attention layers/blocks, such as conformer layers/blocks. In some examples, the number of conformer layers/blocks in the audio encoder is equal to 17 with 512-dimensional layers. The audio encoder 210 may include 100 million parameters. Here, each conformer block includes a series of multi-headed self attention, depth wise convolution and feed-forward layers. The stack of self-attention layers/blocks may include transformer layers/blocks in other examples. The prediction network 220 may have one 512-dimensional LSTM layer. Alternatively, the prediction network 220 may include a stack of transformer or conformer blocks, or an embedding look-up table in lieu of LSTM layers. Finally, the joint network 230 may include two (2) feedforward layers with a 512-dimensional intermediate layer. The Softmax layer 240 may be composed of a unified word piece or grapheme set that is generated using all unique word pieces or graphemes in a plurality of training data sets. The Softmax layer 240 may include a 1024-dimensional layer corresponding to 1,024 wordpiece targets. The prediction network 220, the joint network 230, and the Softmax layer 240 may collectively form an RNN-T decoder 250 of the RNN-T model 200. Thus, the speech decoder 250 of FIG. 1 may include the RNN-T decoder 250.

Referring back to FIG. 1, the audio encoder 210 is configured to receive, as input, the sequence of audio frames 102 characterizing the prefix portion 106a of the utterance 106 and generate, as output, a corresponding sequence of prefix encodings 212. The speech decoder 250 (e.g., RNN-T decoder) is configured to process the corresponding sequence of the prefix encodings 212 to generate the partial speech recognition hypothesis 180a for the prefix portion 106a of the utterance 106.

The sequence of audio frames 102 may include an input sequence of mel-frequency spectrogram frames. In some examples, the audio encoder 210 operates in a streaming manner. That is, for each respective audio frame 102 in the sequence of audio frames 102, the audio encoder 210 generates a corresponding prefix encoding 212 and passes the corresponding prefix encoding 212 to the speech decoder 250 of the speech recognition model 200. As such, at each time step (e.g., output step) of a plurality of time steps, the audio encoder 210 generates a corresponding prefix encoding 212. The audio encoder 210 may additionally or alternatively operate in a non-streaming mode and process look-ahead or right context audio frames 102 when generating a prefix encoding 212 for a corresponding audio frame 102. In some implementations, the audio encoder 210 includes a cascaded audio encoder that includes a causal encoder and a non-causal encoder stacked on top of the causal encoder.

The prefix embedding multi-head attention layer 170 of the SSR model 120 is configured to receive, as input, the sequence of prefix encodings 212 encoded by the audio encoder 210 and a query prompt Q characterized by a sequence of M trainable query vectors 172, q₁, . . . , q_{M}, and generate, as output, a prefix prompt embedding (A^{P}) 175. The M trainable query vectors 172 may include soft prompt query vectors. Here, the keys and values of the prefix embedding multi-head attention layer 170 are the projections of the prefix encodings 212 output from the audio encoder 210, while the queries of the prefix embedding multi-head attention layer 170 are the projections of the of the M trainable query vectors (q₁, . . . , q_{M}) 172. Thus, the prefix embedding multi-head attention layer 170 processes the sequence of prefix encodings 212 conditioned on the sequence of the M trainable query vectors (q₁, . . . , q_{M}) 172 to generate the prefix prompt embedding (A^{P}) 175 as a fixed-length summary of the prefix encodings 212 represented by M audio-dependent embeddings a₁, . . . , a_{M}. Notably, the prefix encodings 212 are rich in lexical content since they correspond to encodings directly used by the speech recognition model 200 for speech recognition. Moreover, the prefix prompt embedding (A^{P}) 175 is provided as a prefix to the LM 160 to reduce, and keep fixed, a computational cost of the subsequent decoding performed by the LM 160 compared to processing the prefix encodings 212 directly. In some examples, M is equal to 64 trainable query vectors 172 (equivalent in length to 2.56 seconds of audio frames 102) of 1,024 dimensions and the prefix embedding multi-head attention layer 170 includes a single 1,024-dimensional cross-attention layer with four heads for computing the prefix prompt embedding 175.

The LM 160 processes the partial speech recognition hypothesis 180a generated by the speech recognition model 200 conditioned on the prefix prompt embedding (A^{P}) 175 to generate the SSR hypothesis 180b for the suffix portion of the utterance 106. Moreover, the LM 160 is finetuned with low-rank (LoRA) adapters 161 along with the trainable query vectors 172 and parameters of the prefix embedding multi-head attention layer 170 to teach the LM 160 to learn how to speculate ideal suffix tokens to complete provide the best SSR hypothesis 180b for the suffix portion of the utterance 106 that completes the partial speech recognition hypothesis 180a for the prefix portion of the utterance 106. While examples herein disclose using LoRA adapters 161 as a parameter-efficient finetuning (PEFT) technique for the LM 160, the LM 160 may be finetuned using other PEFT techniques without departing from the scope of the present disclosure, such as adapters, residual adapters, or other sub-models having trainable parameters for adapting the pertained LM 160 on the SSR task. The SSR model 120 uses the speech recognition model 200 to predict the partial speech recognition hypothesis (Ŷ^{P}=y₁, . . . , yᵣ) 180a from the sequence of audio frames (X^{P}) 102 characterizing the prefix portion 106a of the utterance and the LM 160 is used to predict the SSR hypothesis Ŷ^{S}=yᵣ₊₁, . . . , y_{U}) 180b by conditioning the LM 160 on the audio-dependent prefix prompt embedding (A^{P}) 175 and the partial speech recognition hypothesis 180a as follows:

$$P ( Y \vert {X}^{P} ) = {P}_{θ} ( {Y}^{P} \vert {X}^{P} ) {\prod }_{u = 1}^{U} {P}_{{∅}_{e} , θ , Q , ζ} ( {y}_{u} \vert {y}_{< u ,} {X}^{P} ) \qquad ( 1 )$$

Where ζ denotes the parameters of the prefix embedding multi-head attention layer 170, θ denotes the parameters of the LM 160, φₑ denotes the parameters of the audio encoder 210 of the speech recognition model 200, and Q denotes the trainable query vectors 172.

Notably, the LM 160 generates the SSR hypothesis 180b for the suffix portion of the utterance 106 before the user speaks, and thus before the SSR model 120 processes any audio characterizing, the suffix portion of the utterance 106. In the example, the SSR hypothesis 180b for the suffix portion of the utterance 106 is “-sident of Liberia”. Accordingly, the transcription 180 is “who is the president of Liberia” formed by the partial speech recognition hypothesis 180a (“who is the pre-”) and the SSR hypothesis 180b (“-sident of Liberia). In some examples, the LM 160 generates an n-best list of candidate SSR hypotheses and a Softmax of the LM 160 selects the SSR hypothesis 180b from the n-best list of candidate SSR hypotheses. For instance, in the example shown in FIG. 1, the n-best list of candidate SSR hypotheses for the suffix portion of the utterance 106b may include “-sident of Liberia”, “-sident's husband”, “-sent head of NASA”, “-ss secretary”.

The LM 160 may include a 100 million parameter LM decoder having eight (8) 1,024-dimensional multi-head attention layers, each split into 16 attention heads, and including a tied embedding-softmax with the same 1,024 word piece units as the output softmax layer 240 of the RNN-T decoder 250. In some examples, the multi-head attention layers of the LM 160 include Transformer layers.

Notably, while simply using a hybrid model that stacks the speech recognition model 120 in cascade with the LM 160 where the speech recognition model generates and feeds the partial speech recognition hypothesis 180a for the prefix portion 106a of the utterance 106 to the LM will provide speculations of likely completions for the hypotheses of the suffix portion of the utterance 106, such an architecture is limited in that the LM 160 is pretrained for generic text completion, and, consequently, does not account for the idiosyncrasies of operating on a speech recognition output. Specifically, the LM 160 would not account for the fact that the only input is the partial speech recognition hypothesis 180a generated by the speech recognition model 200 and may contain errors. Stated differently, the LM 160 would not consider valuable information contained in the speech frames 102 which may be lost in the text-only partial speech recognition hypothesis 180a, but would be useful for speculation. Accordingly, the SSR model 120 disclosed herein prepends the prefix prompt embedding 175 as an audio-dependent soft prompt to the partial speech recognition hypothesis 180a as input to the LM 160. As shown in FIG. 1, grey-shaded components of the SSR model 120 that include the trainable query vectors 172, the prefix embedding multi-head attention layer 170, and the LoRA adapters 161 are fine-tuned on the SSR task while parameters of the audio encoder 210, speech decoder 250, and LM 160 are held fixed.

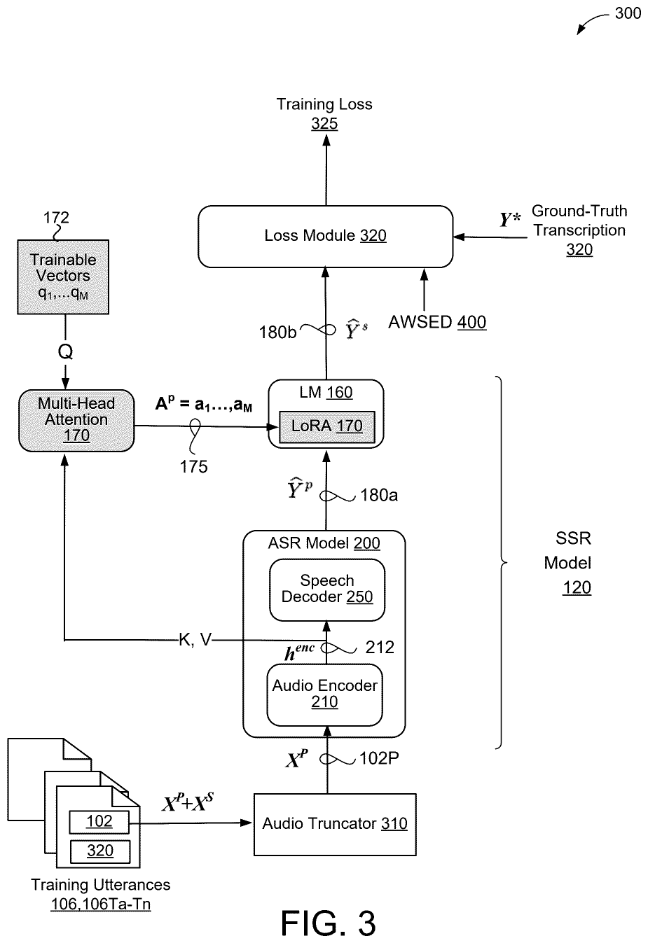

Referring to FIG. 3, a training process 300 for fine-tuning the parameters Δθ of the LoRA adapters 161 of the LM 160 along with the tied embedding-softmax layer of the LM 160, the parameters (ζ) of the prefix embedding multi-head attention layer 170, and the soft prompt trainable query vectors (Q) 172 on a plurality of training utterances 106, 106Ta-106T to maximize a log-likelihood of predicting a ground-truth suffix portion (Y^{S}) 106b of each training utterance 106T. Each training utterance 106T includes a corresponding sequence of audio frames 102 paired with a corresponding ground-truth transcription 320. For each training utterance 106T, an audio truncator 310 truncates a suffix portion (X^{S}) 102S from the corresponding sequence of audio frames 102 to provide a prefix sequence of the audio frames (X^{P}) 102P that characterizes a prefix portion 106a of the training utterance 106T. For instance, the truncator 310 may truncate a fixed-length number of the last audio frames 102 in the sequence of audio frames 102. In some examples, the fixed-length number is equal to a duration of about one (1) second of audio. Thereafter, the remaining prefix sequence of the audio frames 102P.

The audio encoder 210 processes each audio frame in the prefix sequence of the audio frames (X^{P}) 102P to generate a corresponding sequence of prefix audio encodings 212 that is fed to both the speech decoder 250 and the prefix embedding multi-head attention layer 170. The speech decoder 250 processes the sequence of prefix audio encodings 212 associated with the prefix portion of the training utterance to generate, as output, a partial speech recognition hypothesis (Ŷ^{P}) 180a for the prefix portion of the training utterance. The partial speech recognition hypothesis (Ŷ^{P}) 180a may be represented as a sequence of tokens (y₁, . . . , yᵣ) that transcribe the prefix portion of the training utterance. Simultaneously, the prefix embedding multi-head attention layer 170 receives the sequence of M trainable query vectors (q₁, . . . , q_{M}) 172 and processes the sequence of prefix encodings 212 conditioned on the sequence of M training query vectors 172 to generate a prefix prompt embedding (A^{P}=a₁ . . . , a_{M}) 175. Thereafter, the LM 160 modified by the LoRA adapters 161 processes the partial speech recognition hypothesis 180a generated by the speech recognition model 200 conditioned on the prefix prompt embedding 175 to generate a SSR hypothesis (Y^{S}) 180b for the truncated suffix portion (X^{S}) of the corresponding sequence of audio frames 102. The LoRA adapters 161 may include a rank set depending on the type of training utterances the LoRA adapters 161 are finetuned on during the training process. For instance, the rank of the LoRA adapters 161 may be set equal to 10 for single-domain training utterances to provide 12 million trainable parameters to be finetuned for speculation. In other instances, the rank of the LoRA adapters 161 may be set equal to 50 for multi-domain training utterances to provide 19 million trainable parameters to be finetuned for speculation.

The SSR hypothesis (Y^{S}) 180b may be represented as a sequence of tokens (yᵣ₊₁, . . . , y_{U}). In some examples, the LM 160 generates a plurality of candidate SSR hypothesis, such as an n-best list of candidate SSR hypotheses. A loss module 320 determines a training loss 325 based on the SSR hypothesis (Y^{S}) 180b (or the plurality of candidate SSR hypotheses) and the ground-truth transcription 320 of the training utterance 106T. The training process 300 finetunes the LoRA adapters (Δθ) 161 of the LM 160 along with the tied embedding-softmax layer of the LM 160, the parameters (ζ) of the prefix embedding multi-head attention layer 170, and the soft prompt trainable query vectors (Q) 172 based on the training loss 325.

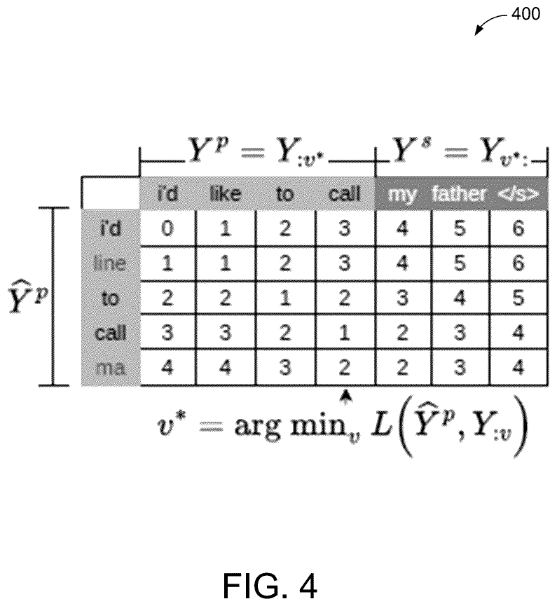

As the partial speech recognition hypothesis (Ŷ^{P}) 180a generated by the speech recognition model 200 for the prefix sequence of audio frames X^{P} is represented by the sequence of tokens (y₁, . . . , yᵣ), determining the r for training, however, is not a trivial task. Consider, for example, a training utterance whose ground-truth transcription (Y) 320 is “i'd like to call my father”, but for which the speech recognition model 200 generates “i'd line call ma-” as the partial speech recognition hypothesis (PP) 180a for the prefix sequence of audio frames X^{P}. Due to the error generated by the speech recognition model 200, a correct suffix portion of the ground-truth transcription is not clearly defined. Accordingly, it is necessary for the SSR model 120 to first be trained to determine what part of the ground-truth transcription 120 has been output by the speech recognition model 200, perhaps erroneously, and what part remains to be speculated. To address this paradigm, FIG. 4 depicts the training process 300 executing an Alignment With Subsequence Edit Distance (AWSED) procedure 400, whereby a Levenshtein distance is computed between the partial speech recognition hypothesis Ŷ^{P} and all left-substrings of the ground-truth transcription Y. More specifically, by taking the left- and right-substring of the ground-truth transcription Y at some index v respectively as Y_{:v}:=(y₁, . . . , yᵥ) and Y_{v:}:=(yᵥ₊₁, . . . , y_{U}), then a target suffix, Y^{S}=Y_{v*:}, where:

$$v * = arg {min}_{v} L ( {\hat{Y}}^{P} , {Y}_{: v} ) \qquad ( 2 )$$

where L(s₁,s₂) is the Levenshtein distance between strings s₁ and s₂. Notably, rather computing L(Ŷ^{P}, Y_{:v}) separately for each v, the training process 300 only requires one run of the AWSED procedure for computing the Levenshtein distance to get v* because the last row of the matrix depicted in FIG. 4 of accumulated costs already contains L(Ŷ^{P}, Y_{:v})∀v and only the arg min of this row is required. In the event multiple indices are tied for the arg min, the AWSED procedure 400 will pick the leftmost one. Continuing with the example, the AWSED procedure 400 yields the resulting Y^{S} as “-my father”. The training process 300 may then use stochastic gradient descent to finetune. For each mini-batch B, the training process minimizes the cross-entropy by, with respect to the parameters ζ of the prefix embedding multi-head attention layer 170, the soft prompt trainable query vectors Q, and the parameters Δθ of the LoRA adapters 161:

$${J}_{B} = - {\sum }_{( X , Y ) ∈ B} {\sum }_{u = v * + 1}^{U} log {P}_{{φ}_{e} , θ + θ Δ , Q , ζ} ( {y}_{u} \vert {X}^{P} ) \qquad ( 3 )$$

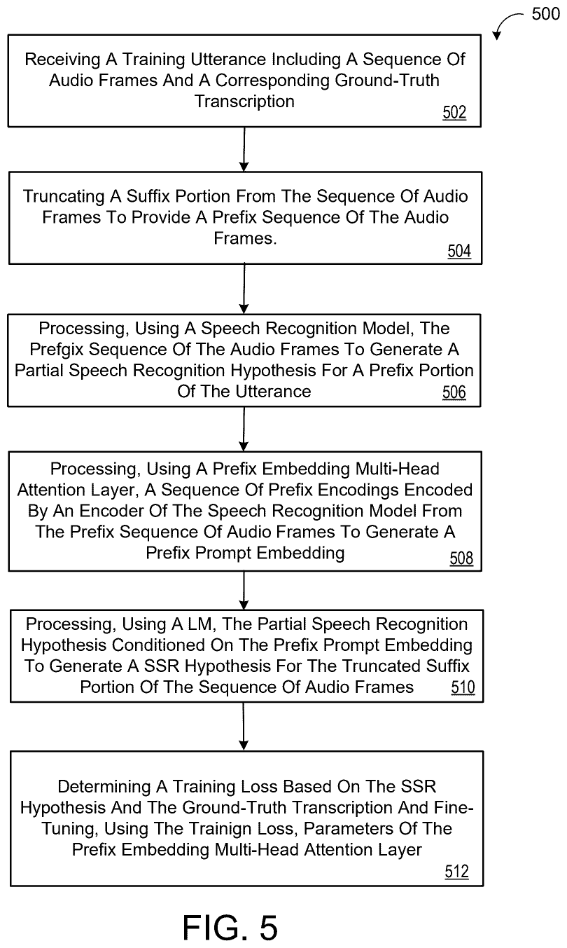

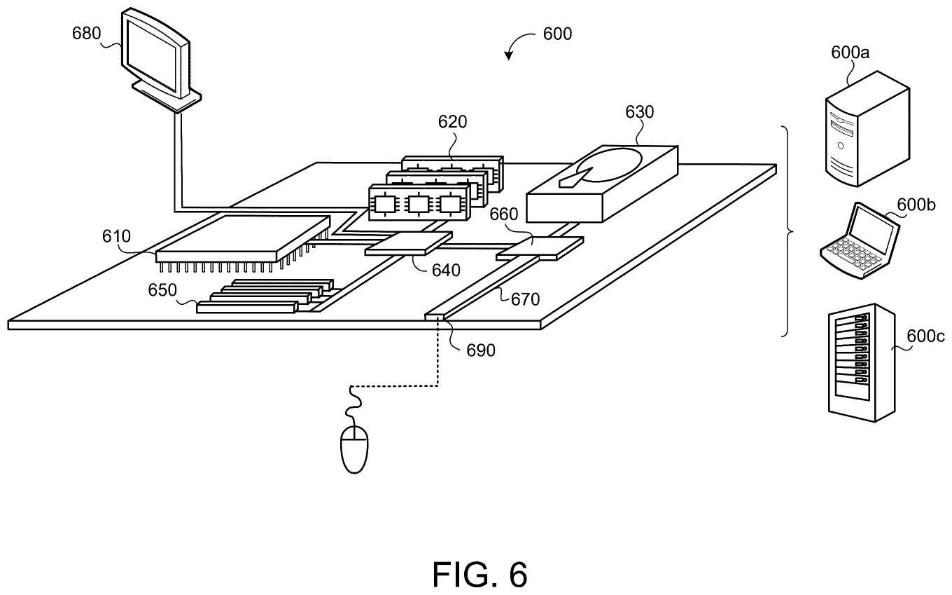

FIG. 5 includes a flowchart of an example arrangement of operations for a computer-implemented 500 of training a speculative speech recognition (SSR) model 120 to accurately generate a full transcription 180 of an utterance 106 spoken by a user 10 before the user 10 has finished speaking the utterance 106. The operations for the method 500 can be described with reference to the training process 300 of FIG. 3 and the SSR model 120 of FIG. 1. The method 500 may execute on data processing hardware 610 (FIG. 6) using instructions stored on memory hardware 620 (FIG. 6) that may reside on the user device 110 and/or the remote system 140 of FIG. 1 each corresponding to a computing device 600 (FIG. 6).

At operation 502, the method 500 includes receiving a training utterance 106, 106T including a sequence of audio frames 102 characterizing an utterance and a corresponding ground-truth transcription 180 of the utterance. At operation 504, the method 500 includes truncating (e.g., via truncator 310 (FIG. 3)) a suffix portion from the sequence of audio frames 102 to provide a prefix sequence of the audio frames 102P that characterizes a prefix portion of the utterance.

At operation 506, the method includes processing, using a speech recognition model 200 including an encoder 210 and a decoder 250, the prefix sequence of the audio frames 102P to generate a partial speech recognition hypothesis 180a for the prefix portion of the utterance 106. At operation 508, the method 500 includes processing, using a prefix embedding multi-head attention layer 170, a sequence of prefix encodings 212 encoded by the encoder 210 of the speech recognition model 200 from the prefix sequence of audio frames 102P to generate a prefix prompt embedding 175.

At operation 510, the method includes processing, using a language model (LM) 160, the partial speech recognition hypothesis 180a generated by the speech recognition model 200 conditioned on the prefix prompt embedding 175 to generate a speculated speech recognition hypothesis 180b for the truncated suffix portion of the sequence of audio frames 102.

At operation 512, the method 500 includes determining a training loss 325 based on the speculated speech recognition hypothesis 180b and the ground-truth transcription 320 of the utterance 106 and fine-tuning, using the training loss 325, parameters ζ of the prefix embedding multi-head attention layer 170.

FIG. 6 is a schematic view of an example computing device 600 that may be used to implement the systems and methods described in this document. The computing device 600 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 600 includes a processor 610, memory 620, a storage device 630, a high-speed interface/controller 640 connecting to the memory 620 and high-speed expansion ports 650, and a low speed interface/controller 660 connecting to a low speed bus 670 and a storage device 630. Each of the components 610, 620, 630, 640, 650, and 660, are interconnected using various busses, and may be mounted on a common motherboard or in other manners as appropriate. The processor 610 can process instructions for execution within the computing device 600, including instructions stored in the memory 620 or on the storage device 630 to display graphical information for a graphical user interface (GUI) on an external input/output device, such as display 680 coupled to high speed interface 640. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 620 stores information non-transitorily within the computing device 600. The memory 620 may be a computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 630 is capable of providing mass storage for the computing device 600. In some implementations, the storage device 630 is a computer-readable medium. In various different implementations, the storage device 630 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 620, the storage device 630, or memory on processor 610.

The high speed controller 640 manages bandwidth-intensive operations for the computing device 600, while the low speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and a low-speed expansion port 690. The low-speed expansion port 690, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 600a or multiple times in a group of such servers 600a, as a laptop computer 600b, or as part of a rack server system 600c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
receiving a training utterance comprising a sequence of audio frames characterizing an utterance and a corresponding ground-truth transcription of the utterance;
truncating a suffix portion from the sequence of audio frames to provide a prefix sequence of the audio frames that characterizes a prefix portion of the utterance;
processing, using a speech recognition model comprising an encoder and a decoder, the prefix sequence of the audio frames to generate a partial speech recognition hypothesis for the prefix portion of the utterance;
processing, using a prefix embedding multi-head attention layer, a sequence of prefix encodings encoded by the encoder of the speech recognition model from the prefix sequence of audio frames to generate a prefix prompt embedding;
processing, using a language model (LM), the partial speech recognition hypothesis generated by the speech recognition model conditioned on the prefix prompt embedding to generate a speculated speech recognition hypothesis for the truncated suffix portion of the sequence of audio frames;
determining a training loss based on the speculated speech recognition hypothesis and the ground-truth transcription of the utterance; and
fine-tuning, using the training loss, parameters of the prefix embedding multi-head attention layer.

2. The computer-implemented method of claim 1, wherein the operations further comprise:
obtaining a sequence of trainable query vectors,
wherein processing the sequence of prefix encodings encoded by the encoder to generate the prefix prompt embedding comprises processing, using the prefix embedding multi-head attention layer, the sequence of prefix encodings and the sequence of trainable query vectors to generate the prefix prompt embedding.

3. The computer-implemented method of claim 2, wherein:
the trainable query vectors comprise soft prompt query vectors; and
fine-tuning further comprises fine-tuning the trainable query vectors.

4. The computer-implemented method of claim 1, wherein fine-tuning further comprises performing parameter-efficient fine-tuning (PEFT) to only update a subset of existing or newly added parameters of the LM based on the training loss.

5. The computer-implemented method of claim 4, wherein:
the LM is pre-trained and comprises a plurality of multi-head attention blocks;
the pre-trained LM is modified to add two low-rank projection matrices to each multi-head attention block; and
performing PEFT comprises fine-tuning only the parameters of the low-rank projection matrices added to the pre-trained LM while existing parameters of the pre-trained LM remain fixed.

6. The computer-implemented method of claim 1, wherein:
the encoder of the speech recognition model comprises a pre-trained audio encoder comprising a plurality of multi-head attention layers each comprising a multi-head attention mechanism; and
parameters of the pre-trained audio encoder are held fixed.

7. The computer-implemented method of claim 6, wherein the multi-head attention layers comprise Conformer layers.

8. The computer-implemented method of claim 1, wherein the LM comprises a plurality of multi-head attention layers.

9. The computer-implemented method of claim 8, wherein the multi-head attention layers comprise Transformer layers.

10. The computer-implemented method of claim 1, wherein the speech recognition model comprises a recurrent neural network-transducer architecture.

11. A system comprising:
data processing hardware; and
memory hardware in communication with the data processing hardware and storing instructions that when executed on the data processing hardware causes the data processing hardware to perform operations comprising:
receiving a training utterance comprising a sequence of audio frames characterizing an utterance and a corresponding ground-truth transcription of the utterance;
truncating a suffix portion from the sequence of audio frames to provide a prefix sequence of the audio frames that characterizes a prefix portion of the utterance;
processing, using a speech recognition model comprising an encoder and a decoder, the prefix sequence of the audio frames to generate a partial speech recognition hypothesis for the prefix portion of the utterance;
processing, using a prefix embedding multi-head attention layer, a sequence of prefix encodings encoded by the encoder of the speech recognition model from the prefix sequence of audio frames to generate a prefix prompt embedding;
processing, using a language model (LM), the partial speech recognition hypothesis generated by the speech recognition model conditioned on the prefix prompt embedding to generate a speculated speech recognition hypothesis for the truncated suffix portion of the sequence of audio frames;
determining a training loss based on the speculated speech recognition hypothesis and the ground-truth transcription of the utterance; and
fine-tuning, using the training loss, parameters of the prefix embedding multi-head attention layer.

12. The system of claim 11, wherein the operations further comprise:
obtaining a sequence of trainable query vectors,
wherein processing the sequence of prefix encodings encoded by the encoder to generate the prefix prompt embedding comprises processing, using the prefix embedding multi-head attention layer, the sequence of prefix encodings and the sequence of trainable query vectors to generate the prefix prompt embedding.

13. The system of claim 12, wherein:
the trainable query vectors comprise soft prompt query vectors; and
fine-tuning further comprises fine-tuning the trainable query vectors.

14. The system of claim 11, wherein fine-tuning further comprises performing parameter-efficient fine-tuning (PEFT) to only update a subset of existing or newly added parameters of the LM based on the training loss.

15. The system of claim 14, wherein:
the LM is pre-trained and comprises a plurality of multi-head attention blocks;
the pre-trained LM is modified to add two low-rank projection matrices to each multi-head attention block; and
performing PEFT comprises fine-tuning only the parameters of the low-rank projection matrices added to the pre-trained LM while existing parameters of the pre-trained LM remain fixed.

16. The system of claim 11, wherein:
the encoder of the speech recognition model comprises a pre-trained audio encoder comprising a plurality of multi-head attention layers each comprising a multi-head attention mechanism; and
parameters of the pre-trained audio encoder are held fixed.

17. The system of claim 16, wherein the multi-head attention layers comprise Conformer layers.

18. The system of claim 11, wherein the LM comprises a plurality of multi-head attention layers.

19. The system of claim 18, wherein the multi-head attention layers comprise Transformer layers.

20. The system of claim 11, wherein the speech recognition model comprises a recurrent neural network-transducer architecture.
